(19) United States
(12) Patent Application Publication
(10) Pub. No.: US 2025/0201976 A1
(43) Pub. Date: Jun. 19, 2025

(54) BATTERY AND MODULE

(71) Applicant: TOYOTA JIDOSHA KABUSHIKI KAISHA, Toyota-shi (JP)

(72) Inventors: Kota OHATA, Toyota-shi (JP); Masahiro ISHIZUKA, Toyota-shi (JP); Hajime HASEGAWA, Aichi-gun (JP); Mitsuru TATEISHI, Toyota-shi (JP); Norihiro OSE, Nagoya-shi (JP); Masashi CHIHARA, Nagoya-shi (JP)

(73) Assignee: TOYOTA JIDOSHA KABUSHIKI KAISHA, Toyota-shi (JP)

(21) Appl. No.: 18/812,027

(22) Filed: Aug. 22, 2024

(30) Foreign Application Priority Data
Dec. 13, 2023 (JP) 2023-210504

(51) Int. Cl. H01M 50/124; H01M 50/105; H01M 50/117; H01M 50/131; H01M 50/211; H01M 50/224; H01M 50/46

(52) U.S. Cl. CPC H01M 50/124; H01M 50/105; H01M 50/117; H01M 50/131; H01M 50/211; H01M 50/224; H01M 50/46

(57) ABSTRACT

A battery of the present disclosure includes an electrode body and a laminate exterior body that houses the electrode body. The electrode body is formed by alternately laminating a positive electrode body and a negative electrode body via a separator. The laminate exterior body includes a hard layer having electrical insulation on at least one surface of the electrode body side.

### CROSS-REFERENCE TO RELATED APPLICATION

This application claims priority to Japanese Patent Application No. 2023-210504 filed on Dec. 13, 2023, incorporated herein by reference in its entirety.

### BACKGROUND

### 1. Technical Field

The present disclosure relates to a battery and a module.

### 2. Description of Related Art

US 2017/0155102 A discloses a lithium secondary battery (hereinafter also referred to as “battery”). The battery includes an electrode assembly (hereinafter also referred to as “electrode body”) and a case (hereinafter also referred to as “exterior body”) that houses the electrode body. The exterior body is formed of a multilayer laminate sheet. The laminate includes an insulating layer having an elongation of 10% or more. “Elongation” refers to the rate of deformation of an object fractured during testing relative to its untested state. As the material of the insulating layer, a polyurethane-based resin, an epoxy resin, a fluororesin, a polyimide-based resin, a polyester-based resin, and a polyolefin-based resin are disclosed. In such a battery, when a physical force is applied from an external conductive object (e.g., a nail), the insulating layer is elongated in a shape to wrap the electrode body. Thus, the insulating layer suppresses the occurrence of direct contact between the external conductive object and the electrode body, and suppresses the occurrence of direct contact between a cathode and an anode included in the electrode body.

### SUMMARY

In the manufacturing process for the battery, a foreign substance (e.g., metal powder during ultrasonic bonding between a current collector and a tab) may adhere to the outer surface of the laminate exterior body. When a module is structured by housing a plurality of batteries in a metal case, the foreign substance (e.g., chippings of the metal case) may adhere to the outer surface of the laminate exterior body. In the battery disclosed in US 2017/0155102 A, the foreign substance is likely to penetrate the insulating layer. As a result, the foreign substance may short-circuit the electrode body.

The present disclosure has been made in view of the above circumstances. An object of an embodiment of the present disclosure is to provide a battery and a module in which occurrence of a short circuit of an electrode body is suppressed.

The means for addressing the above object includes the following aspects.

<1> A battery according to a first aspect of the present disclosure includes: an electrode body in which cathode bodies and anode bodies are alternately laminated via separators; and
a laminate exterior body that houses the electrode body.
   The laminate exterior body includes a hard layer at a portion overlapping the electrode body when viewed in a thickness direction of the electrode body.

The “laminate exterior body” refers to a case made of a laminate sheet. The “laminate sheet” refers to a sheet including a metal layer, a first resin layer laminated on one principal surface of the metal layer, and a second resin layer laminated on the other principal surface of the metal layer. The “hard layer” refers to a layer that is harder than aluminum. Specifically, the hard layer is a layer having a Mohs hardness of 3.0 or more. In other words, the elongation of the hard layer is less than 10%.

In the manufacturing process for the battery, a foreign substance (e.g., metal powder during ultrasonic bonding between a current collector and a tab) may adhere to the outer surface of the laminate exterior body. When a module is structured by housing a plurality of batteries in a metal case, the foreign substance (e.g., chippings of the metal case) may adhere to the outer surface of the laminate exterior body.

In the first aspect, the laminate exterior body includes the hard layer at the portion overlapping the electrode body when viewed in the thickness direction of the electrode body. The foreign substance is less likely to penetrate the hard layer. Thus, the foreign substance is less likely to enter the inside of the laminate exterior body than in the configuration in which the laminate exterior body does not include the hard layer. As a result, the occurrence of a short circuit of the electrode body is suppressed in the battery of the first aspect.

<2> In the battery according to the first aspect of the present disclosure, the hard layer may have an electrical insulation property.

The term “hard layer having electrical insulation property” refers to a hard layer having an electrical resistivity of 10¹⁰ Ω·m or more.

In the battery of the first aspect, the occurrence of the short circuit of the electrode body is further suppressed.

<3> In the battery according to the first aspect of the present disclosure, the hard layer may include at least either of ceramics and glass.

In the first aspect, the Mohs hardness of the hard layer is relatively high. As a result, the occurrence of the short circuit of the electrode body is further suppressed in the battery of the first aspect.

<4> In the battery according to the first aspect of the present disclosure, the laminate exterior body may be flat, and each of two principal surfaces of the laminate exterior body may include a surface on the electrode body side.

In the first aspect, the foreign substance is less likely to enter the inside of the laminate exterior body than in the configuration in which the hard layer is not formed on the surface on the electrode body side in each of the two principal surfaces of the laminate exterior body. As a result, the occurrence of the short circuit of the electrode body is further suppressed in the battery of the first aspect.

<5> A module according to a second aspect of the present disclosure includes:
a plurality of the batteries according to the first aspect; and
a metal case that houses the batteries.

In the module of the second aspect, the occurrence of the short circuit of the electrode body is suppressed.

The present disclosure provides the battery and the module in which the occurrence of the short circuit of the electrode body is suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a module of an embodiment of the present disclosure;

FIG. 2 is a top view of a module with a case lid removed according to an embodiment of the present disclosure;

FIG. 3 is a front view of a battery according to an embodiment of the present disclosure; and

FIG. 4 is a cross-sectional view taken along IV-IV line of FIG. 3.

### DETAILED DESCRIPTION OF EMBODIMENTS

Hereinafter, embodiments of the present disclosure will be described. These descriptions and examples are illustrative of the embodiments and are not intended to limit the scope of the embodiments.

In the present disclosure, a combination of two or more preferred embodiments is a more preferred embodiment.
In the present disclosure, a numerical range expressed using “to” means a range including numerical values described before and after “to” as a lower limit value and an upper limit value.
In the numerical ranges described in the present disclosure in a stepwise manner, the upper limit value or the lower limit value described in one numerical range may be replaced with the upper limit value or the lower limit value of the numerical range described in another stepwise manner. In the numerical ranges described in the present disclosure, the upper limit value or the lower limit value of the numerical range may be replaced with the value shown in the examples.

Hereinafter, embodiments of a battery and a module of the present disclosure will be described with reference to the drawings. In the drawings, the same or corresponding parts are denoted by the same reference numerals, and description thereof will not be repeated.

### (1.1) Module

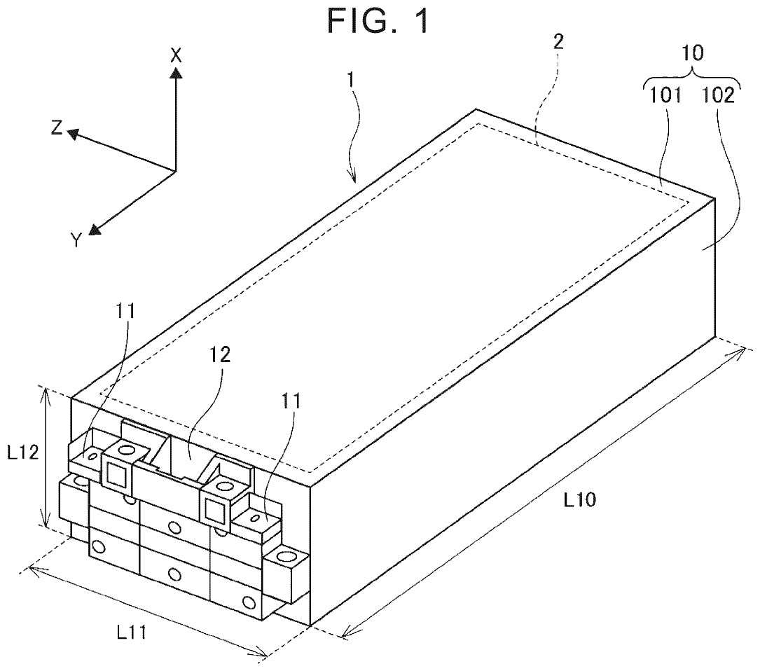

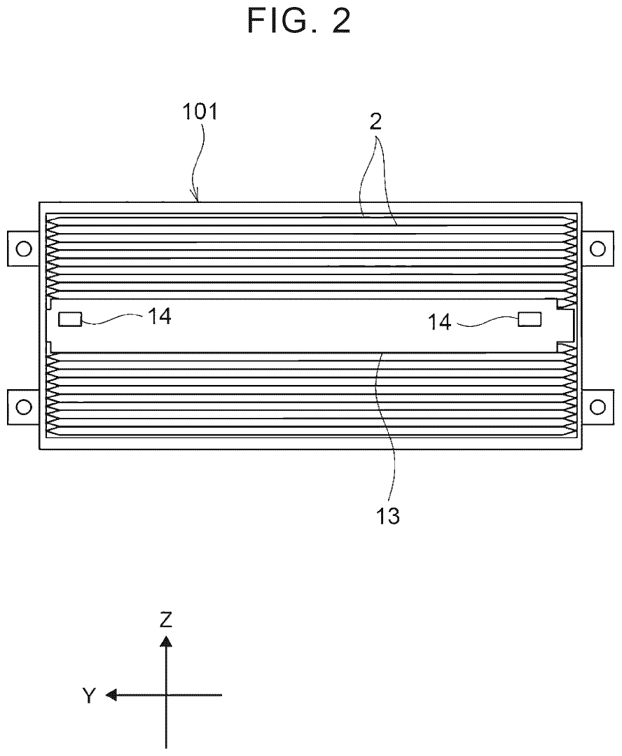

As illustrated in FIGS. 1 and 2, a module 1 according to an embodiment of the present disclosure includes a plurality of batteries 2 and a metal case 10. The metal case 10 houses a plurality of batteries 2. The module 1 is a rectangular parallelepiped.

In the present embodiment, the thickness direction of the module 1 is defined as the X-axis direction, the longitudinal direction of the module 1 is defined as the Y-axis direction, and the lateral direction of the module 1 is defined as the Z-axis direction. Each of the X-axis, the Y-axis, and the Z-axis is orthogonal to each other. Note that these orientations do not limit the orientation of the battery and module of the present disclosure when used.

The length L10 of the module 1 in the Y-axis direction (see FIG. 1) is, for example, 350 mm to 600 mm. The length L11 of the module 1 in the Z-axis direction (see FIG. 1) is, for example, 150 mm to 250 mm. The length L12 of the module 1 in the X-axis direction (see FIG. 1) is, for example, 80 mm to 110 mm.

A pair of voltage terminals 11 and a connector 12 are provided at both ends of the module 1 in the Y-axis direction, respectively. A flexible printed circuit board 13 to be described later is connected to the connector 12. Bus bars (not shown) are welded to both ends of the module 1 in the Y-axis direction.

The metal case 10 includes a metal case main body 101 and a metal case lid 102. The metal case 10 is made of an aluminum alloy. The metal case 10 is formed, for example, by joining aluminum die-casting to both end portions of an extruded material of an aluminum alloy by laser welding or the like.

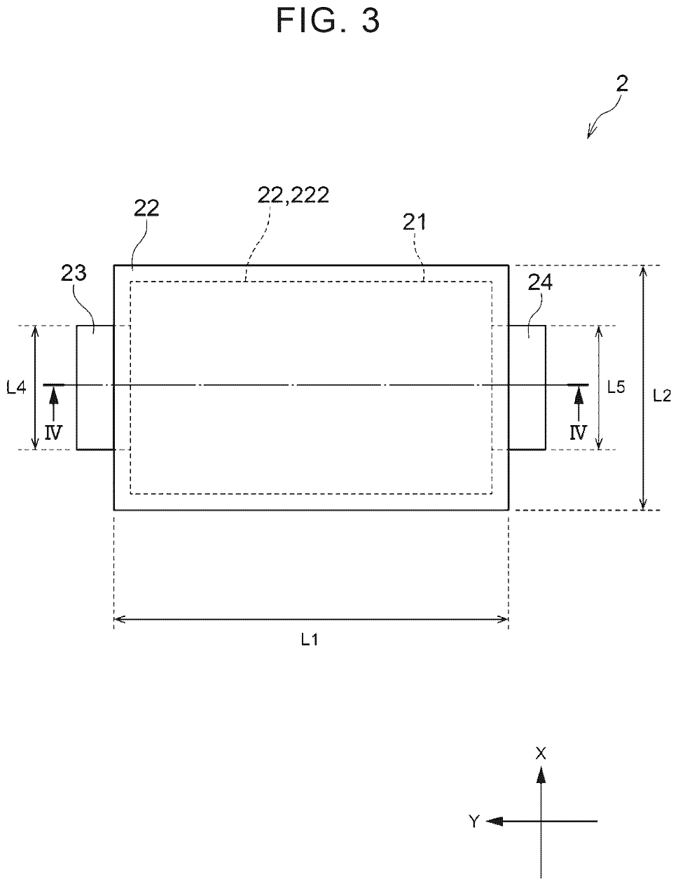

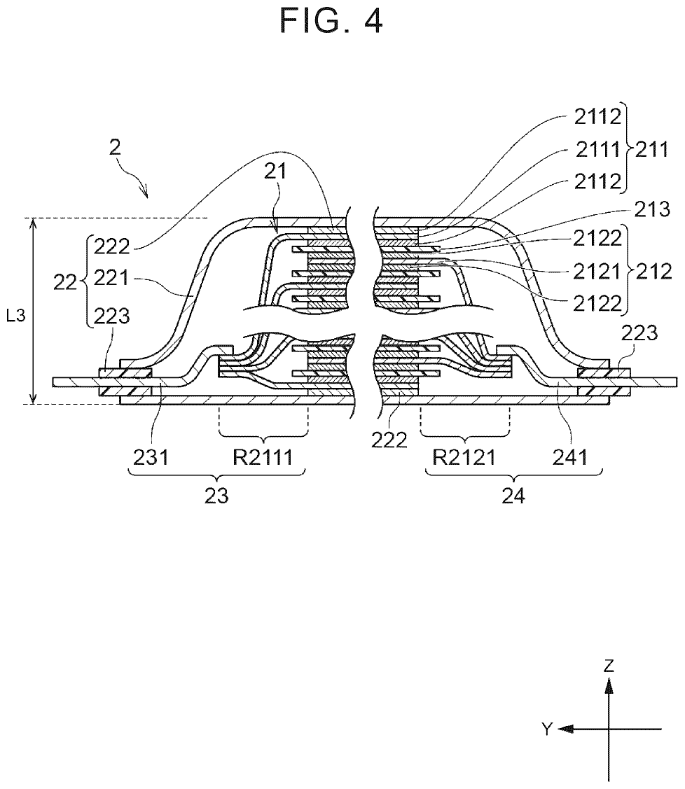

As shown in FIG. 2, a plurality of batteries 2 are accommodated in the module 1 in an arranged state. In the present embodiment, 24 batteries 2 are arranged along the Z-axis direction. The adjacent batteries 2 are bonded to each other. The details of the battery 2 will be described later with reference to FIGS. 3 and 4.

A flexible printed circuit board (FPC: Flexible Printed Circuit) 13 is disposed on the batteries 2. The flexible printed circuit board 13 is formed in a band shape with the Y-axis direction as a longitudinal direction, and thermistors 14 are provided at both end portions of the flexible printed circuit board 13. In the module 1, the thermistor 14 is not adhered to the battery 2 and is pressed toward the battery 2 by the metal case lid 102.

One or more cushioning materials (not shown) are accommodated in the module 1. For example, the cushioning material is an elastically deformable thin plate-shaped member, and is disposed between the adjacent batteries 2 with the arrangement direction of the batteries 2 as the thickness direction. In the present embodiment, as an example, cushioning materials are disposed at both end portions in the longitudinal direction of the module 1 and at a central portion in the longitudinal direction.

### (1.2) Battery

As shown in FIG. 3, the battery 2 includes an electrode body 21, a laminate exterior body 22, a positive electrode tab 23, a negative electrode tab 24, and a non-aqueous electrolyte (not shown). The battery 2 is a rectangular parallelepiped.

The laminate exterior body 22 contains an electrode body 21 and a non-aqueous electrolyte solution. The positive electrode tab 23 protrudes from the laminate exterior body 22 in the Y-axis positive direction. The negative electrode tab 24 protrudes from the laminate exterior body 22 in the Y-axis negative direction.

The length L1 of the battery 2 in the Y-axis direction (see FIG. 3) is, for example, 530 mm to 600 mm. The length L2 of the battery 2 in the X-axis direction (see FIG. 3) is, for example, 80 mm to 110 mm. The length L3 of the battery 2 in the Z-axis direction (see FIG. 4) is, for example, 7.0 mm to 9.0 mm.

### (1.2.1) Electrode Body

The structure of the electrode body 21 is a laminated type. As illustrated in FIG. 4, the electrode body 21 includes a plurality of positive electrode sheets 211, a plurality of negative electrode sheets 212, and a plurality of separator sheets 213. The electrode body 21 is formed by alternately laminating the positive electrode sheet 211 and the negative electrode sheet 212 along the Z-axis direction via the separator sheet 213.

The number of each of the positive electrode sheet 211, the negative electrode sheet 212, and the separator sheet 213 is not particularly limited, and is appropriately selected according to the use of the battery 2 and the like.

### (1.2.1.1) Positive Electrode Sheet

The positive electrode sheet 211 includes a positive electrode current collector 2111 (for example, an aluminum foil or the like) and a positive electrode active material layer 2112 supported on both surfaces of the positive electrode current collector 2111. The positive electrode active material layer 2112 includes a positive electrode active material. The active cathode material releases lithium ions into or occludes from the non-aqueous electrolyte. The positive electrode active material may be any known positive electrode active material (e.g., LiNiO₂, LiNi_{1/3}Co_{1/3}Mn_{1/3}O₂). The positive electrode active material layer 2112 may further contain a known conductive material (e.g., carbon black, etc.), trithium phosphate, a known binder (e.g., polyvinylidene fluoride, etc.).

### (1.2.1.2) Negative Electrode Sheet

The negative electrode sheet 212 includes a negative electrode current collector 2121 (for example, a copper foil or the like) and a negative electrode active material layer 2122 supported on both surfaces of the negative electrode current collector 2121. The negative electrode active material layer 2122 includes a negative electrode active material. The negative electrode active material occludes lithium ions, which are charge carriers, from the non-aqueous electrolytic solution and releases them to the non-aqueous electrolytic solution in accordance with charge and discharge. The negative electrode active material may be any known negative electrode active material (artificial graphite, lithium-alloy (for example, LiXM, M is C, Si, Sn, Sb, Al, Mg, Ti, Bi, Ge, Pb, or P, and X is a natural number)). The negative electrode active material layer 2122 may further contain a known binder (for example, a styrene-butadiene copolymer or the like).

### (1.2.1.3) Separator Sheet

The separator sheet 213 electrically insulates the positive electrode sheet 211 and the negative electrode sheet 212, and provides a path for lithium ions to move between the positive electrode active material layer 2112 and the negative electrode active material layer 2122. Examples of the separator sheet 213 include a porous film. Examples of the material of the porous film include polyethylene and polypropylene. The separator sheet 213 may have a single-layer structure or a multi-layer structure.

### (1.2.2) Laminate Exterior Body

The laminate exterior body 22 covers the electrode body 21 and seals the electrode body 21 and the nonaqueous electrolyte solution together with the positive electrode tab 23 and the negative electrode tab 24. In the present embodiment, the laminate exterior body 22 has a single-cup structure (see FIG. 4). The “laminate exterior body having a single cup structure” refers to a single laminate exterior body having a folding line, a single cup portion (recessed portion) capable of accommodating the entire electrode body, and a flat portion, wherein the flat portion covers the recessed portion by being bent along the folding line. The laminate exterior body 22 has a flat shape.

As shown in FIG. 4, the laminate exterior body 22 includes a laminate sheet 221, two hard layers 222, and a plurality of tab films 223. In the present embodiment, the hard layer 222 is formed on the surface of both main surfaces of the laminate exterior body 22 on the electrode body 21 side. Each of the plurality of tab films 223 is welded to the positive electrode tab 23 or the negative electrode tab 24 and the laminate sheet 221.

### (1.2.2.1) Laminate Sheet

The laminate sheet 221 includes a metal layer, an inner resin layer, and an outer resin layer. The inner resin layer is laminated on the surface of the metal layer on the electrode body 21 side. The outer resin layer is laminated on a surface of the metal layer opposite to the electrode body 21 side. The metal layer blocks gas (e.g., moisture, air, etc.) from entering and leaving the outside of the battery 2 and the inside of the battery 2. The material of the metal layer is a metal (for example, aluminum or the like). The inner resin layer electrically insulates the electrode body 21, the positive electrode tab 23, and the negative electrode tab 24 from the metal layer. The inner resin layer may include a thermoplastic resin. The outer resin layer improves the durability of the laminate sheet 221. The outer resin layer may include a thermoplastic resin. Examples of the thermoplastic resin of each of the inner resin layer and the outer resin layer include olefin-based resins (for example, polypropylene and polyethylene), polyvinyl chloride, and polyvinylidene chloride.

### (1.2.2.2) Hard Layer

The hard layer 222 is electrically insulating. In other words, the resistivity of the hard layers 222 is greater than or equal to 10¹⁰ Ω·m. The Mohs hardness of the hard layer 222 is 3.0 or more. In other words, the elongation of the hard layer 222 is less than 10%.

As shown in FIG. 3, when viewed in the thickness direction (Z-axis direction) of the electrode body 21, each of the two hard layers 222 is formed so as to cover the entire electrode body 21. In other words, the laminate exterior body 22 includes two hard layers 222 in a portion overlapping with the electrode body 21 when viewed in the thickness direction (Z-axis direction) of the electrode body 21.

The thickness of the hard layer 222 is not particularly limited, and is appropriately selected according to the material of the hard layer 222. The thickness of the hard layers 222 may be, for example, 1.0 mm.

In the present embodiment, the hard layer 222 includes ceramics and may be made of ceramics. Examples of the ceramics include oxide ceramics and nitride ceramics. Examples of the oxide-based ceramics include silica, titania, zirconia, magnesia, ceria, yttria, zinc oxide, iron oxide, cordierite, mullite, and alumina. Examples of the nitride-based ceramics include silicon nitride, titanium nitride, and boron nitride. These ceramics may be used in one type alone, or may be used in combination of two or more types.

### (1.2.2.3) Tab Film

The tab film 223 has a function of electrically insulating the laminate sheet 221, the positive electrode tab 23, and the negative electrode tab 24, and a function of bonding the laminate sheet 221, the positive electrode tab 23, and the negative electrode tab 24. The tab film 223 includes a thermoplastic resin. Examples of the thermoplastic resin of the tab film 223 include the same as those exemplified as the thermoplastic resin of each of the inner resin layer and the outer resin layer.

### (1.2.4) Positive Tabs

The positive electrode tab 23 is electrically connected to the plurality of positive electrode current collectors 2111. The positive electrode tab 23 includes a metallic sheet 231 and a positive electrode lead portion R2111 of the positive electrode current collector 2111. The metallic sheet 231 and the positive electrode lead portion R2111 are electrically connected to each other. Examples of the material of the metallic sheet 231 include metal (for example, aluminium, stainless steel (SUS), and the like). The length L4 of the positive electrode tab 23 in the X-axis direction is, for example, 40 mm to 50 mm.

### (1.2.5) Negative Electrode Tab

The negative electrode tab 24 is electrically connected to the plurality of negative electrode current collectors 2121. The negative electrode tab 24 includes a metallic sheet 241 and a negative electrode lead portion R2121 of the negative electrode current collector 2121. The metallic sheet 241 and the negative electrode lead portion R2121 are electrically connected to each other. Examples of the material of the metallic sheet 241 include metal (e.g., SUS). The length L5 of the negative electrode tabs 24 in the X-axis direction is, for example, 40 mm to 50 mm.

### (1.2.6) Nonaqueous Electrolyte

The battery 2 includes a non-aqueous electrolyte solution. The non-aqueous electrolytic solution is housed in the laminate exterior body 22 together with the electrode body 21. The non-aqueous electrolyte solution may be obtained by dissolving or dispersing a supporting salt (for example, LiPF₆) as an electrolyte in a non-aqueous solvent (for example, ethyl carbonate or the like). The nonaqueous electrolyte may contain various additives such as lithium bis(oxalato) borate.

### (1.3) Action and Effect

As described with reference to FIGS. 1 to 4, the battery 2 includes an electrode body 21 and a laminate exterior body 22. The laminate exterior body 22 has a hard layer 222 at a portion overlapping with the electrode body 21 when viewed in the thickness direction of the electrode body.

As a result, foreign matter (for example, cutting chips of the metal case 10, metal powder at the time of ultrasonic bonding between the positive electrode current collector 2111 and the positive electrode tab 23, metal powder at the time of ultrasonic bonding between the negative electrode current collector 2121 and the negative electrode tab 24, and the like) hardly penetrates the hard layer 222. As a result, the foreign matter is less likely to enter the inside of the laminate exterior body 22 than in the configuration in which the laminate exterior body 22 does not include the hard layer 222. As a result, in the battery 2, occurrence of a short circuit of the electrode body 21 is suppressed.

The laminate exterior body 22 may have the hard layer 222 on at least one of the surface on the electrode body 21 side and the surface on the opposite side of both main surfaces of the laminate exterior body 22. It is preferable to have a hard layer 222 on the surfaces of both main surfaces of the laminate exterior body 22 on the electrode body 21 side.

As described with reference to FIGS. 1 to 4, in the battery 2, the hard layer 222 is electrically insulating.

As a result, in the battery 2, occurrence of a short circuit of the electrode body is further suppressed.

As described with reference to FIGS. 1 to 4, in the battery 2, the hard layer 222 includes ceramics.

That is, the Mohs hardness of the hard layer 222 is higher. As a result, in the battery 2, occurrence of a short circuit of the electrode body is further suppressed.

As described with reference to FIGS. 1 to 4, in the battery 2, the laminate exterior body 22 is flat, and the laminate exterior body 22 preferably has a hard layer 222 on the surface of both main surfaces of the laminate exterior body 22 on the electrode body 21 side. Accordingly, the foreign matter is less likely to enter the inside of the laminate exterior body 22 than in the configuration in which the hard layer 222 is not provided on the surface of both main surfaces of the laminate exterior body 22 on the electrode body 21 side. As a result, in the battery 2, occurrence of a short circuit of the electrode body 21 is further suppressed.

As described with reference to FIGS. 1 to 4, the module 1 includes a plurality of batteries 2 and a metal case 10.

Thus, in the module 1, occurrence of a short circuit of the electrode body 21 is suppressed.

### (2) Modification

In the present embodiment, the hard layer 222 is electrically insulating, but the present disclosure is not limited thereto, and the hard layer 222 may not be electrically insulating if the Mohs hardness is 3.0 or more.

In the present embodiment, the hard layer 222 includes ceramics, but the present disclosure is not limited thereto, and the hard layer 222 may not include ceramics as long as the Mohs hardness is 3.0 or more. The hard layer 222 may include glass. Examples of the glass include borosilicate glass, quartz glass, 96% quartz glass, soda-lime glass, aluminoborosilicate glass, aluminosilicate glass, lead glass, and neoceram.

The hard layer 222 preferably includes at least one of ceramics and glass. Thus, the Mohs hardness of the hard layer 222 is relatively high. As a result, in the battery 2, occurrence of a short circuit of the electrode body 21 is further suppressed.

In the present embodiment, the laminate exterior body 22 is flat, but the present disclosure is not limited thereto, and may not be flat. In the present embodiment, the laminate exterior body 22 has the hard layer 222 on both main surfaces on the electrode body 21 side, but the present disclosure is not limited thereto. The laminate exterior body 22 may have a hard layer 222 on one main surface on the electrode body 21 side.

In the present embodiment, the positive electrode tab 23 includes the metallic sheet 231 and the positive electrode lead portion R2111 of the positive electrode current collector 2111. The positive electrode tab 23 may be formed of the positive electrode lead portion R2111 of the positive electrode current collector 2111.

In the present embodiment, the laminate exterior body 22 has a single-cup structure (see FIG. 4), but the present disclosure is not limited thereto. In the present disclosure, the laminate exterior body 22 may have a double cup structure. The laminate exterior body of the “double cup structure” is a laminate exterior body having the following structure. The laminate exterior body of the “double cup structure” has a bending line, one first cup portion (recessed portion) capable of accommodating a portion of the electrode body, and one second cup portion (recessed portion) capable of accommodating a portion of the electrode body. The laminate exterior body of the “double cup structure” is one laminate exterior body capable of accommodating the entire electrode body in a space formed by overlapping the first cup portion and the second cup portion by being bent along a bending line.

In the present embodiment, the positive electrode tab 23 protrudes from the laminate exterior body 22 in the Y-axis positive direction, and the negative electrode tab 24 protrudes from the laminate exterior body 22 in the Y-axis negative direction, but the present disclosure is not limited thereto. In the present disclosure, the positive electrode tab 23 and the negative electrode tab 24 may protrude from the laminate exterior body 22 in the Y-axis positive direction or the Y-axis negative direction.

In the present embodiment, the number of batteries 2 accommodated in the module 1 is 24, but the present disclosure is not limited thereto. The number of batteries 2 accommodated in the module 1 may be less than 23 or 25 or more.

In the present embodiment, the use of the battery 2 is a vehicle power supply, but the present disclosure is not limited thereto. In the present disclosure, the use of the battery 2 may be, for example, a power supply for an information processing apparatus (for example, a personal computer, a smartphone, or the like), a power supply for power storage, or the like.

What is claimed is:

1. A battery comprising:
an electrode body in which cathode bodies and anode bodies are alternately laminated via separators; and
a laminate exterior body that houses the electrode body, wherein the laminate exterior body includes a hard layer at a portion overlapping the electrode body when viewed in a thickness direction of the electrode body.

2. The battery according to claim 1, wherein the hard layer has an electrical insulation property.

3. The battery according to claim 2, wherein the hard layer includes at least either of ceramics and glass.

4. The battery according to claim 3, wherein:
the laminate exterior body is flat; and
each of two principal surfaces of the laminate exterior body includes a surface on the electrode body side.

5. A module comprising:
a plurality of the batteries according to claim 1; and
a metal case that houses the batteries.
